(19) United States
(12) Patent Application Publication
(10) Pub. No.: US 2005/0223405 A1
(43) Pub. Date: Oct. 6, 2005

(54) Program information receiving apparatus, program information receiving method, and program information receiving program

(75) Inventors: Yutaka Iizuka, Tokyo (JP); Akihito Kikuchi, Tokyo (JP)

Correspondence Address: ARENT FOX PLLC, 1050 CONNECTICUT AVENUE, N.W., SUITE 400, WASHINGTON, DC, 20036, US

(73) Assignee: Pioneer Corporation

(21) Appl. No.: 11/092,696

(22) Filed: Mar. 30, 2005

(30) Foreign Application Priority Data
Mar. 31, 2004 (JP) JP2004-102365

(51) Int. Cl. H04N 5/445; G06F 13/00; G06F 3/00

(52) U.S. Cl. 725/52; 725/53; 725/45

(57) ABSTRACT

A program information receiving apparatus includes: a search criterion registration section for registering a search criterion necessary for searching through program information for a desired program; a program information acquisition section for acquiring program information; an updated information extraction section for comparing newly acquired program information and existing program information with each other to extract an updated part; a program information search section for searching the updated part for program information based on the search criterion; and a search result output section for outputting a search result when the desired program is found as a result of the search by the program information search section. Thus, a user can monitor not only program information fetched and stored in the receiving apparatus but also program information to be transmitted in the future for a program that the user wants to watch.

### BACKGROUND OF THE INVENTION

The present invention relates to a program information receiving apparatus, a program information receiving method, and a program information receiving program.

The present application claims priority from Japanese Patent Application No. 2004-102365, the disclosure of which is incorporated herein by reference.

With the development of broadcasting techniques in recent years, various information (the contents or programs) are broadcasted in various systems such as a terrestrial broadcasting (analog or digital) system, a BS (Broadcasting Satellite; analog or digital) system, and a CS (Communication Satellite; analog or digital) system. Various receiving apparatuses for receiving the broadcasted information directly or via connection such as the Internet or a CATV (Cable Television) have been developed. The receiving apparatuses in question include a receiving apparatus dedicated to each of various broadcasting systems or common to the broadcasting systems, a receiving apparatus functioning by a program incorporated into a computer, a receiving apparatus included in or integrated with a television, and the like.

Some of the receiving apparatuses have a function of receiving and using program information of broadcast programs (for example, a so-called EPG (Electronic Program Guide)) solely or in addition to reception of broadcast contents consisting of video images, sounds, characters, and the like.

Japanese Patent Application Laid-Open Publication No. 2003-9033 describes a conventional technique related to a digital broadcast receiving apparatus for receiving digital broadcast. According to the conventional technique, the receiving apparatus has an EPG display function, a category search function, and a message notification function. The category search function serves to extract a program having category information corresponding to a category input by a user by using program category information in the EPG. If a program desired by the user is present in the received and fetched EPG, the message notification function actively notifies the user of a message from the apparatus side so as to display the message on a currently displayed screen in an interrupted manner or to display the message on the screen at power ON.

According to such a conventional technique, once the user provides information of a program that the user wants to watch in advance as selected information, all the user has to do is keep watching another program. When a program corresponding to the selected information is found by a search, the receiving apparatus actively generates an interrupt to the screen, on which the program being watched is displayed, so as to notify the user of the search result. Alternatively, if a program corresponding to the selected information has been found by a search before the TV is switched ON, the receiving apparatus actively displays the search result on the screen at power ON so as to notify the user of the search result. As a result, the user has an advantage in that the user does not have to display the program or the search result provided by the category search function by himself or herself as long as the receiving apparatus is operating. Moreover, the user has benefits that the user can know the search result while watching another program or when the TV is turned ON so as to watch another program.

Generally, the program information of broadcast programs consists of information such as program titles listed for each broadcast system (terrestrial digital or analog broadcasting, BS digital or analog, CS or the like) or each channel and in the order of broadcast time. One information unit merely contains information for a limited period of time (for example, eight days or a month). The information in the information unit is normally updated every several hours. The receiving apparatus has a function of receiving and fetching program information for one information unit each time the program information is updated.

Therefore, according to the above-described conventional technique, even if the user provides information related to a program that the user wants to watch for the receiving apparatus, the receiving apparatus can search only through program information within a specific period of time, which is received and is currently stored in the receiving apparatus. If information of the program that the user wants to watch is not found in the program information that is currently stored in the receiving apparatus, it is apparent that the receiving apparatus can not perform notification display.

Specifically, in order not to miss a program that the user wants to watch, expecting that the program will be transmitted in the future, it is necessary to operate the receiving apparatus each time the program information is updated and then to provide information related to the program that the user wants to watch for the receiving apparatus so as to make a search for the program. In practice, the program that the user wants to watch will not be necessarily broadcasted in the future. Moreover, the user cannot get to know future program information. Therefore, for the user side, it is practically difficult to often make a search for the program. Thus, it is virtually impossible with a conventional receiving apparatus to monitor program information including a program to be broadcasted in the future.

Furthermore, according to the conventional technique, only when the receiving apparatus is operating or has been actuated, the user is notified of the search result. Therefore, unless the user actuates the receiving apparatus, the user cannot get the search result for information of the program that the user wants to watch. Thus, in the conventional technique, if the user wants to get the search result for information of the program that the user wants to watch, it is required to actuate the receiving apparatus each time. Accordingly, the operation is disadvantageously troublesome, and is not preferred in view of energy saving.

### SUMMARY OF THE INVENTION

The present invention has an object of coping with such programs as an example. Specifically, the present invention has an object of enabling monitoring not only of program information fetched and stored in a receiving apparatus but also of program information to be transmitted in the future for a program that a user wants to watch, enabling effective and economical notification to the user when the program that the user wants to watch is found, and the like.

In order to achieve the above object, the present invention has at least the configuration according to each of the following aspects.

According to a first aspect of the present invention as set forth in claim 1, a program information receiving apparatus for receiving program information about a broadcast program, comprises: a search criterion registration section for registering a search criterion necessary for searching through the program information for a desired program; a program information acquisition section for acquiring the program information; an updated information extraction section for comparing newly acquired program information and existing program information with each other so as to extract an updated part; a program information search section for searching through the updated part for the program information based on the search criterion; and a search result output section for outputting a search result when the desired program is found as a result of the search by the program information search section.

According to a second aspect of the present invention as set forth in claim 7, a program information receiving method for receiving program information about a broadcast program, comprises the steps of: actuating a program information receiving apparatus at set time so as to acquire program information after a search criterion necessary for searching through the program information for a desired program is registered; comparing newly acquired program information at the acquisition step and existing program information with each other so as to extract an updated part; searching through the updated part for the program information based on the search criterion; outputting a search result when the desired program is found by the search; and notifying a user of the search result based on the output of the search result.

According to a third aspect of the present invention as set forth in claim 8, a computer-readable medium containing a program information receiving program allowing a computer having a function of receiving program information about a broadcast program to be functioned as: a search criterion registration section for registering a search criterion necessary for searching through the program information for a desired program; a program information acquisition section for acquiring the program information; an updated information extraction section for comparing newly acquired program information and existing program information with each other so as to extract an updated part; a program information search section for searching through the updated part for the program information based on the search criterion; and a search result output section for outputting a search result when the desired program is found as a result of the search by the program information search section.

### BRIEF DESCRIPTION OF THE DRAWINGS

These and other objects and advantages of the present invention will become clear from the following description with reference to the accompanying drawings, wherein:

FIG. 1 is an explanatory view showing the configuration of a program information receiving apparatus according to one embodiment of the present invention;

FIG. 2 is an explanatory view showing an example of a program information receiving method according to the embodiment of the present invention;

FIG. 3 is an explanatory view illustrating an example of the present invention;

FIG. 4 is an explanatory view showing an operation or an operation flow of the example;

FIG. 5 is another explanatory view showing an operation or an operation flow of the example;

FIG. 6 is a further explanatory view showing an operation or an operation flow of the example; and

FIGS. 7A to 7C are explanatory views, each showing an example of a search result display screen in the example.

### DETAILED DESCRIPTION OF THE PREFERRED EMBODIMENTS

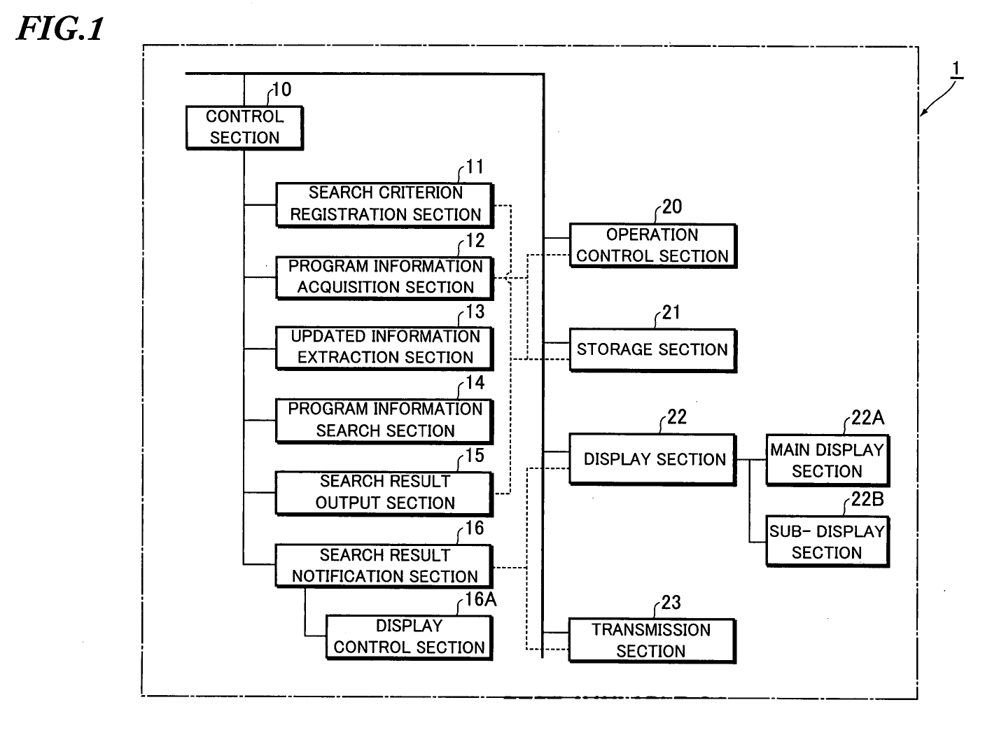

Hereinafter, an embodiment of the present invention will be described with reference to the accompanying drawings. FIG. 1 is an explanatory view showing the configuration of a program information receiving apparatus according to an embodiment of the present invention. A program information receiving apparatus 1 includes: a search criterion registration section 11 controlled by a control section 10 (or incorporated into the control section 10 as a program); a program information acquisition section 12; an updated information extraction section 13; a program information search section 14; a search result output section 15; and a search result notification section 16. In addition, the program information receiving apparatus includes a display control section 16A as needed. The control section 10 is connected to an operation control section 20, a storage section 21, a display section 22 (a main display section 22A and a sub-display section 22B), and a transmission section 23.

In this case, the search criterion registration section 11 has a function of registering a search criterion necessary for searching through program information about broadcast programs for a desired program. The search information acquisition section 12 has a function of acquiring program information. The updated information extraction section 13 has a function of comparing newly acquired program information and existing program information with each other so as to extract an updated part. The program information search section 14 has a function of searching through the above-mentioned updated part for program information based on the search criterion. The search result output section 15 has a function of outputting a search result when a desired program is found as a result of the search by the program information search section 14. The search result notification section 16 has a function of notifying a user of the search result based on the output from the search result output section 15.

As an example of the program information acquisition section 12, the program information receiving apparatus is actuated at set time by the operation control section 20 so as to acquire new program information. The actuation of the program information receiving apparatus 1 may last for a certain period of time, which is long enough for the acquisition of the updated information, or may be stopped at the completion of acquisition.

As an example, information about the search criterion registered by the search criterion registration section 11 or the search result output from the search result output section 16 is transmitted to the storage section 21 so as to be stored in a non-volatile memory of the storage section 21.

Furthermore, as an example of the search result notification section 16, the search result notification section 16 may display the search result on the display section 22 (the main display section 22A) or may include the display control section 16A for blinking or switching display on the sub-display section 22B driven by an auxiliary power source of the program information receiving apparatus 1. Alternatively, as an example of the search result notification section 16, the search result notification section 16 may control the transmission section 24 for transmitting notification information to a portable information terminal (a cell phone or the like) owned by the user or the like.

The program information receiving apparatus 1 having the above-mentioned functions may be a dedicated receiving apparatus for receiving program information solely or with images, sounds, characters and the like of a broadcast program or may be a receiving apparatus built in a television or the like. Alternatively, the program information receiving apparatus 1 may be a computer, on which a program for providing the above-described functions for the computer is installed.

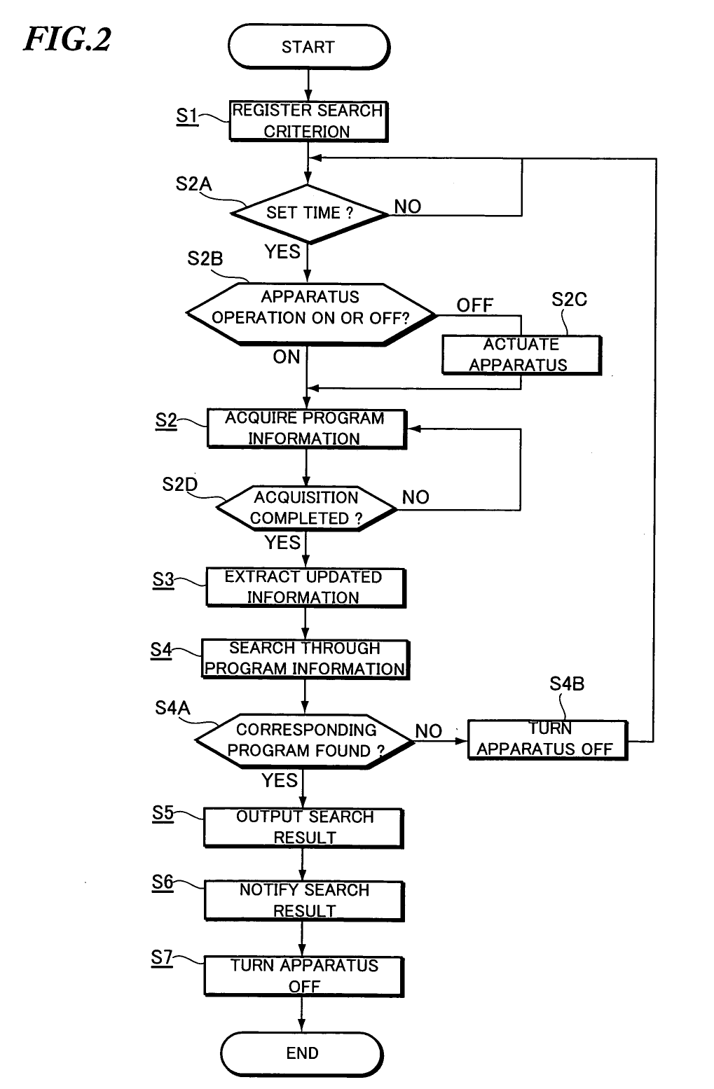

An example of the operation of the program information receiving apparatus 1 according to the above-described embodiment or a program information receiving method (or an implementation procedure of a program information receiving program) implemented by the program information receiving apparatus 1 will be described with reference to FIGS. 1 and 2. First, a search criterion necessary for searching through program information for a desired program is registered in the search criterion registration section 11 of the program information receiving apparatus 1 (S1). The registration can be performed by an input operation by the user or previously registered information can be automatically registered again. Information about the registered search criterion is stored in the non-volatile memory of the storage section 21.

Thereafter, the program information receiving apparatus 1 is actuated at set time (generally, late at night or the like when the user does not use the program information receiving apparatus 1) by the function of the program information acquisition section 12 so as to acquire program information (S2). At this step, by a timer function of the operation control section 20 and the like, the set time is confirmed (S2A). At the set time, an operation status of the program information receiving apparatus 1 is confirmed (S2B). Then, if the program information receiving apparatus 1 is operating in an ON state, the program information is acquired (S2). If the program information receiving apparatus 1 is in an OFF state, the program information receiving apparatus 1 is actuated (S2C) so as to acquire the program information (S2). At this step, the program information receiving apparatus 1 may keep operating for a predetermined period of time, which is long enough for the acquisition of updated information, or may be stopped operating at the completion of acquisition. The acquisition of program information is continued until one information unit (for a predetermined period of time) is acquired (S2D). After the completion of acquisition, the acquired program information for one information unit is stored in the memory of the storage section 21. Subsequently, updated information is extracted (S3).

The extraction of updated information (S3) is carried out by the function of the updated information extraction section 13. The newly acquired program information and existing program information are compared with each other so as to extract an updated part. Information indicating an update version or information indicating a period corresponding to the program information can be added to the program information. By using the information, the following search may be skipped if no update takes place.

Next, a search for the program information based on the search criterion registered by the search criterion registration section 11 is made through the extracted updated part by the function of the program in formation search section 14 (S4). The search condition herein is a criterion for information related to a program contained in the program information such as a program title, a program category, cast, and program description. The presence or the absence of a program corresponding to the search criterion in the updated part of the program information is searched (S4A).

If the corresponding program is not found at this step, the apparatus is turned OFF so as to return to the standby state at the set time (S4B). If at least one corresponding program is found, a search result is output by the function of the search result output section 15 (S5). At the same time, the search result is stored in the non-volatile memory of the storage section 21.

Upon output of the search result, the user is notified of the search result based on the output by the function of the search result notification section 16 (S6). Although various forms can be used as notification means, blinking or switching the display of the sub-display section 22B (for example, time display or the like) driven by the auxiliary power source of the program information receiving apparatus 1 or the like by the function of the display control section 16A is possible as described above. It is also possible to control the transmission section 23 to transmit notification information as a mail or the like to a portable information terminal or the like of the user. Thereafter, the program information receiving apparatus 1 is turned OFF (S7) so as to terminate a series of operations related to registration of a single search criterion (S1).

In this operation, since the information about the registered search criterion and the search result are stored in the non-volatile memory of the storage section 21, the stored contents are retained even when the apparatus is turned OFF. Therefore, by using the information, the search result information can be displayed on a television screen when the television is switched ON or the search result can be displayed on the screen in an interrupted manner during user's viewing or the like in a similar manner to the conventional technique.

According to the program information receiving apparatus 1 (or the program information receiving program) or the program information receiving method having the above-described characteristics, even if no program corresponding to the registered search criterion is found in the received and currently stored program information, programs can be continuously monitored based on the search criterion for program information to be fetched in the future. Therefore, since the user can monitor the program that the user wants to watch over a long period of time, the user can be prevented from missing the desired program as much as possible.

Moreover, if the program corresponding to the registered search criterion is found, the user is notified of the presence of the desired program even when the program information receiving apparatus 1 is not operating. Therefore, it is not necessary for the user to actuate the program information receiving apparatus 1 to know the search result each time. In this manner, the user can know the presence or the absence of the program that the user wants to watch without any troublesome operation. Furthermore, since the apparatus is not operated except for during viewing, it is economical without excessively consuming electric power.

### EXAMPLE

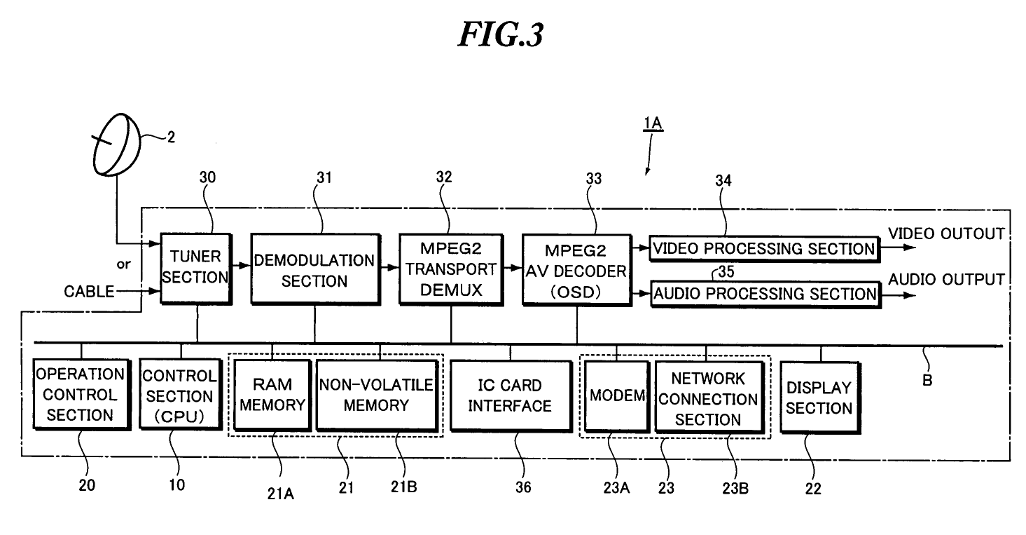

Hereinafter, a further specific example of the present invention will be described. Although the following description will be given taking a digital broadcast receiving apparatus having a program information receiving function as an example, the present invention is not particularly limited thereto. A digital broadcast receiving apparatus 1A according to the example has a basic configuration as shown in FIG. 3. The following components are interconnected through a bas B so as to allow information transfer (the common components to those in the above-described embodiment are denoted by the same reference numerals, and a part of the description thereof is herein omitted).

A tuner section 30 has a function of selecting a desired RF channel in response to a digital broadcast RF signal received through a satellite or terrestrial antenna 2 or a cable.

A demodulation section 31 has a function of demodulating a digital modulated wave of the RF channel selected by the tuner section 30 so as to output an MPEG-2 transport stream.

An MPEG-2 transport demultiplexer (DEMUX) 32 demultiplexes the MPEG-2 transport stream into a video stream, an audio stream, and an SI/PSI. The video stream and the audio stream are transmitted to an MPEG-2 AV decoder 33, whereas the SI/PSI is transmitted to the control section 10.

The MPEG-2 AV decoder 33 includes a video decoder for decoding the video stream and an audio decoder for decoding the audio stream. In this case, the MPEG-2 AV decoder 33 also has a function of superimposing an OSD (On Screen Display) on the video stream.

A video processing section 34 receives the video data from the MPEG-2 AV decoder 33 and performs D/A conversion on the video data so as to generate a video signal. The audio processing section 35 receives the audio data from the MPEG-2 AV decoder 33 and performs D/A conversion on the audio data so as to generate an analog signal for a right sound, an analog signal for a left sound and the like.

The operation control section 20 has the timer function and the like so as to control the operation of the digital broadcast receiving device 1A as described above.

The control section 10 consists of a CPU and the like. As described above, the control section 10 has the program information receiving function provided by the search criterion registration section 11, the program information acquisition section 12, the updated information extraction section 13, the program information search section 14, the search result output section 15, the search result notification section 16 and the like while controlling the above-described components of the digital broadcast receiving apparatus 1A.

The storage section 21 includes at least a RAM memory 21A and a non-volatile memory 21B. The RAM memory 21A is storage means for storing temporary work used by the control section 10, acquired program information and the like. The non-volatile memory 21B is storage means for storing the above-described search criterion, information about the search result or the like.

An IC card interface 36 is an interface for accepting an IC card used for enabling the viewing of a scrambled program such as a pay program by contract.

The transmission section 23 is composed of, for example, a modem 23A and a network connection section 23B. The transmission section 23 has: a function of transmitting notification information to the user by the above-described function of the search result notification section 16; and a function of transmitting and receiving reception control information or connecting to the Internet.

The display section 22 is a display section provided for a main body of the digital broadcast receiving apparatus 1A, and is composed of an LED lamp, a liquid crystal panel, and the like. As described above, the main display section 22A and the sub-display section 22B driven by the auxiliary power source can be provided as the display section 22.

Herein, all the components other than the above-described display section 22 can be turned OFF while the digital broadcast receiving apparatus 1A is in a standby state. The operation is controlled by the timer function of the operation control section 20.

For the program information receiving function of the digital broadcast receiving apparatus 1A having such a basic configuration, the operation by the user or the operation flow will be described for each operation condition. Hereinafter, program information will be referred to as EPG data.

[The Case of the Apparatus in Operation]

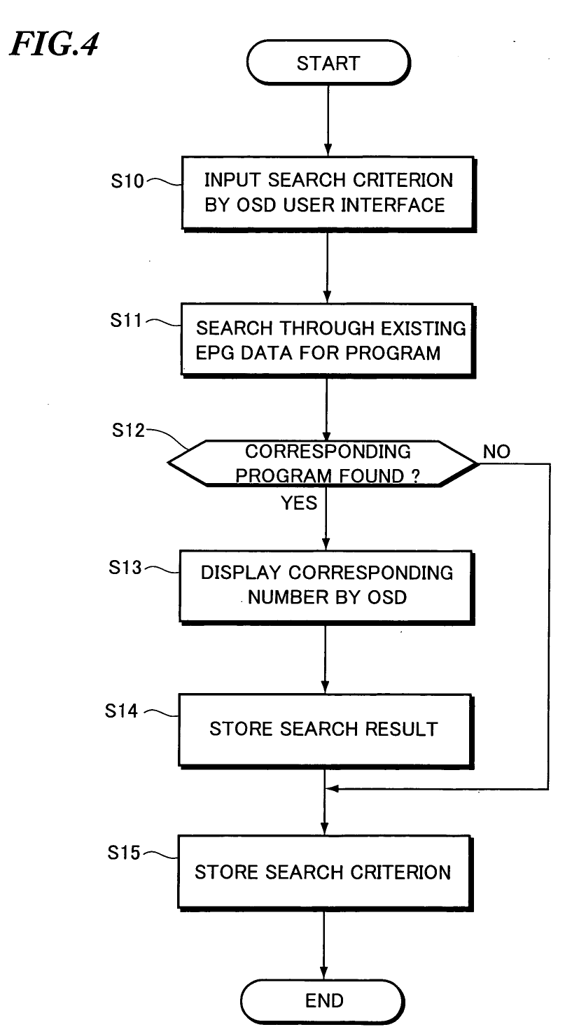

FIG. 4 shows an operation or an operation flow in the case where the user inputs a search criterion while the digital broadcast receiving apparatus 1A is in operation.

When a category of a program desired by the user (movie, music, or the like), a program title, cast, or the like is input as a search criterion as an input operation by the user through an OSD user interface displayed on a television screen (S10), a program search is performed by the function of the program information search section 14 through EPG data corresponding data stored in the non-volatile memory 21B which is then fetched into the RAM memory 21A in advance or existing data in the EPG data fetched into the RAM memory 21A in operation (S11).

If the corresponding program is found as a result of the search (S12), the search result is displayed on the television screen by the OSD at this stage by using the functions of the search result output section 15 and the search result notification section 16 (S13). Thereafter, the search result is stored in the non-volatile memory 21B (S14). On the other hand, no corresponding program is found, the input search criterion is stored in the non-volatile memory 21B (S15) to complete a series of the search operations.

[The Case where the Apparatus is not in Operation]

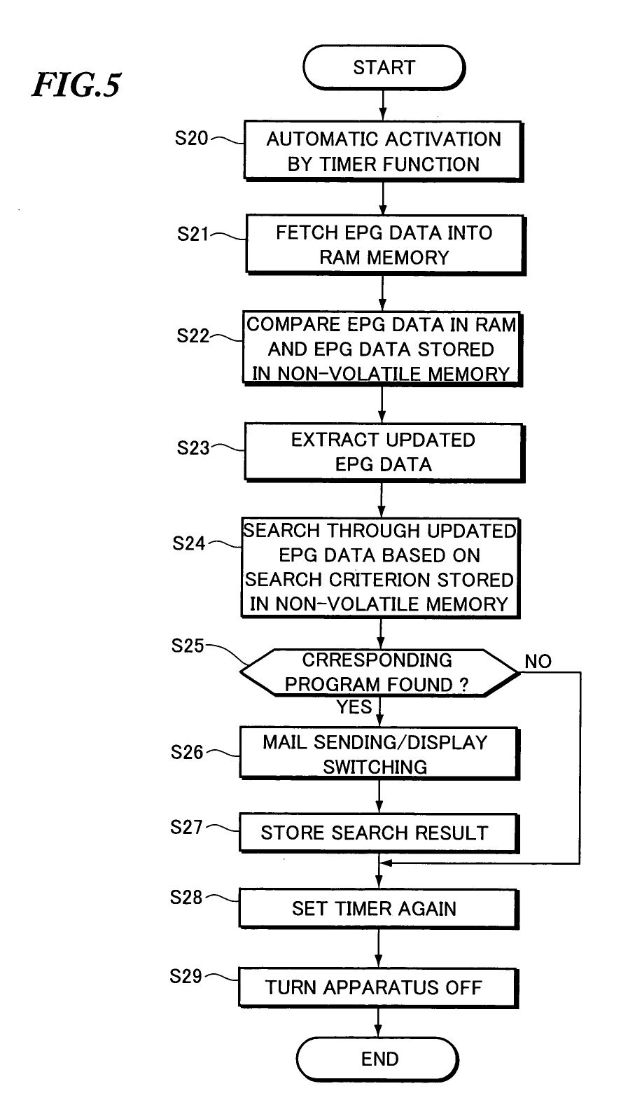

FIG. 5 is a view showing an operation while the digital broadcast receiving apparatus 1A is not in operation, specifically, an operation flow in the case where the user does not use the digital broadcast receiving apparatus 1A.

When the user does not use the digital broadcast receiving apparatus 1A, the digital broadcast receiving apparatus 1A is automatically activated by the timer function of the operation control section 20 (S20). As the set time of the timer, a time zone such as late hours at night, in which the user normally does not use the digital broadcast receiving apparatus 1A, is selected.

Upon the activation of the digital broadcast receiving apparatus 1A by the timer, the EPG data is extracted from the received information so as to fetch new EPG data into the RAM memory 21A (S21). Then, by the function of the updated information extraction section 13, new EPG data in the RAM memory 21A and existing EPG data stored in the non-volatile memory 21B are compared with each other (S22) so as to extract updated EPG data (S23).

Then, by the function of the program information search section 14, a search is made through the updated EPG data based on the search criterion stored in the non-volatile memory 21B (S24). If the corresponding program is found as a result of the search, the user is notified of the presence of the program through means such as mail sending or display switching on the display section 22 by the functions of the search result output section 15 and the search result notification section 16 (S25). Then, the search result is stored in the non-volatile memory 21B (S26), and the timer function is set again (S27). After the digital broadcast receiving apparatus 1A is turned OFF (S28), the digital broadcast receiving apparatus 1A returns to the standby state. On the other hand, if no corresponding program is found, the timer function is set again (S27). After the digital broadcast receiving apparatus 1A is turned OFF (S28), the digital broadcast receiving apparatus 1A returns to the standby state.

[The Case where the Apparatus is in Operation]

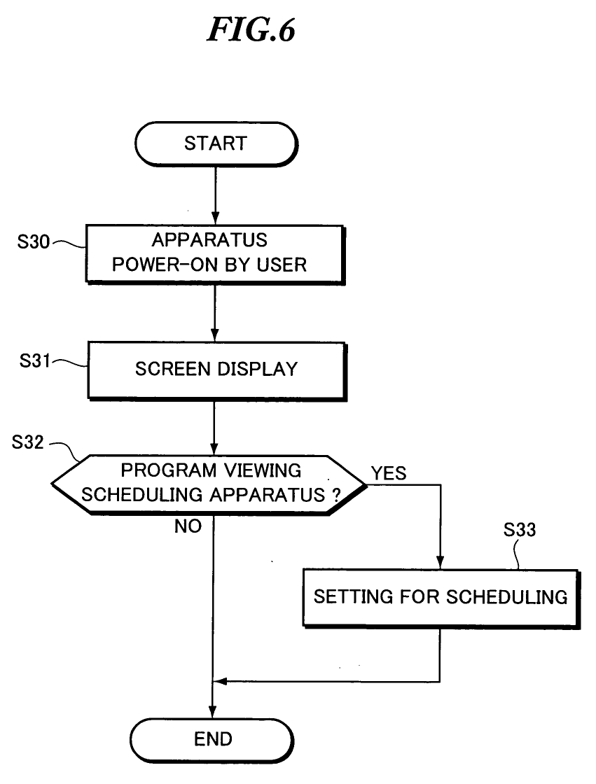

FIG. 6 shows an operation flow in the case where the user who has been notified of the search result turns the digital broadcast receiving apparatus 1A ON. When the user who has been notified of the above-described search result to know the presence of the desired program turns the digital broadcast receiving apparatus 1A ON (S30), the search result is displayed on the screen. For example, by operating the OSD user interface or a remote controller, the search result is read out from the non-volatile memory 21B so as to be displayed.

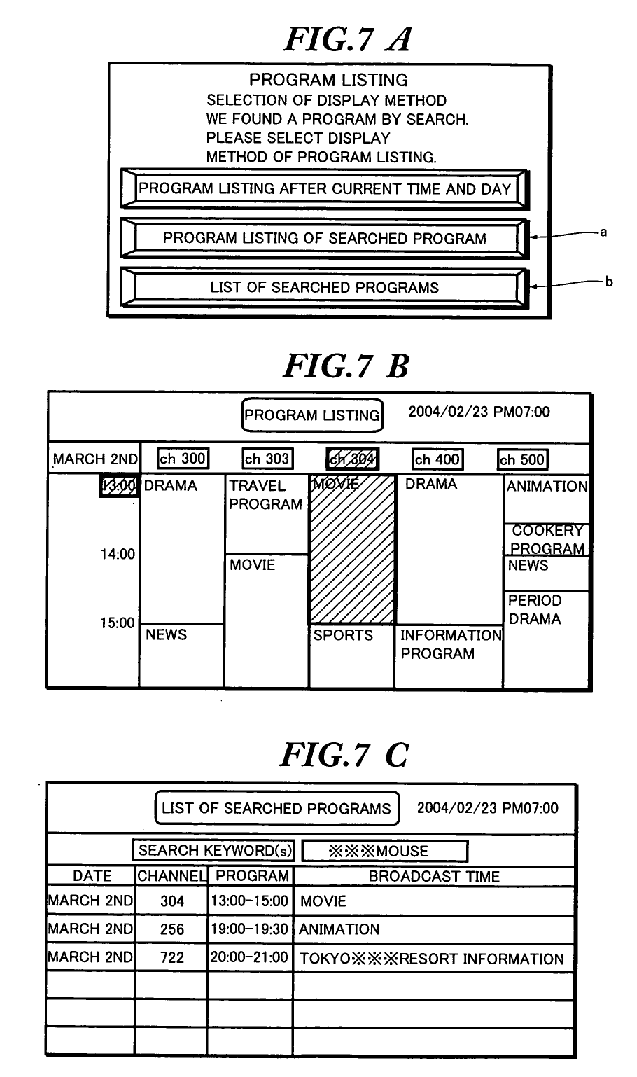

An example of the screen display performed at this step is shown in FIGS. 7A to 7C. As an example, when the user turns the digital broadcast receiving apparatus 1A and the TV ON and presses an “EPG” switch on the remote controller, a selection screen as shown in FIG. 7A is displayed. When an option (a) “program listing including a searched program” is selected by a selection operation of the remote controller, a “program listing” screen as shown in FIG. 7B is displayed. The program found as a result of the search is displayed so as to be highlighted or enhanced. If an option (b) “display a list of searched programs” is selected in FIG. 7A, “a list of searched programs” is displayed on the screen as shown in FIG. 7C.

In accordance with such display screens, the operation of scheduling the viewing of a program can be performed. If the viewing of the program is scheduled, set items for scheduling such as a start time of the program to be viewed, duration, a channel, and the like are stored in the non-volatile memory 21B. The scheduling for setting the start time to the timer is performed (S33).

According to the above-described example, only if the search criterion is registered in the digital broadcast receiving apparatus 1A, a program is automatically searched to store the search result whereas the user is notified of the search result even when the digital broadcast receiving apparatus 1A is not in use and in a standby state. As a result, the user can know that the program the user wants to watch is included in the program information without turning ON the apparatus. The troublesome operation is not needed, while it is effective in view of energy saving.

Furthermore, even if the program that the user wants to watch is not present in the EPG fetched and currently stored in the digital broadcast receiving apparatus 1A, it is possible to continuously monitor the EPG to be fetched in the future for the desired program. As a result, since it is possible to monitor the desired program over a long period of time, the user can effectively get the broadcast schedule of the desired program.

While there has been described what are at present considered to be preferred embodiments of the present invention, it will be understood that various modifications may be made thereto, and it is intended that the appended claims cover all such modifications as fall within the true spirit and scope of the invention.

1. A program information receiving apparatus for receiving program information about a broadcast program, comprising:
a search criterion registration section for registering a search criterion necessary for searching through the program information for a desired program;
a program information acquisition section for acquiring the program information;
an updated information extraction section for comparing newly acquired program information and existing program information with each other so as to extract an updated part;
a program information search section for searching through the updated part for the program information based on the search criterion; and
a search result output section for outputting a search result when the desired program is found as a result of the search by the program information search section.

2. The program information receiving apparatus according to claim 1, wherein
the program information acquisition section actuates the program information receiving apparatus at set time so as to acquire new program information.

3. The program information receiving apparatus according to claim 1, further comprising a non-volatile memory for storing the search criterion and the search result.

4. The program information receiving apparatus according to claim 1, further comprising a search result notification section for notifying a user of the search result based on an output from the search result output section.

5. The program information receiving apparatus according to claim 4, further comprising a display section driven by an auxiliary power source of the program information receiving apparatus, wherein display of the display section is blinked or switched by the search result notification section.

6. The program information receiving apparatus according to claim 4, further comprising a transmission section for transmitting notification information, wherein
the transmission section is controlled by the search result notification section.

7. A program information receiving method for receiving program information about a broadcast program, the method comprising the steps of:
actuating a program information receiving apparatus at set time so as to acquire program information after a search criterion necessary for searching through the program information for a desired program is registered;
comparing newly acquired program information at the acquisition step and existing program information with each other so as to extract an updated part;
searching through the updated part for the program information based on the search criterion;
outputting a search result when the desired program is found by the search; and
notifying a user of the search result based on the output of the search result.

8. A computer-readable medium containing a program information receiving program allowing a computer having a function of receiving program information about a broadcast program to be functioned as:
a search criterion registration section for registering a search criterion necessary for searching through the program information for a desired program;
a program information acquisition section for acquiring the program information;
an updated information extraction section for comparing newly acquired program information and existing program information with each other so as to extract an updated part;
a program information search section for searching through the updated part for the program information based on the search criterion; and
a search result output section for outputting a search result when the desired program is found as a result of the search by the program information search section.
